(19) United States
(12) Patent Application Publication
(10) Pub. No.: US 2013/0315268 A1
(43) Pub. Date: Nov. 28, 2013

(54) TUNABLE OPTICAL FILTER AND OPTICAL SOURCE

(71) Applicant: Electronics and Telecommunications Research Institute, (US)

(72) Inventor: Kwang Ryong OH, Daejeon (KR)

(73) Assignee: Electronics and Telecommunications Research Institute, Daejeon (KR)

(21) Appl. No.: 13/650,283

(22) Filed: Oct. 12, 2012

(30) Foreign Application Priority Data
May 24, 2012 (KR) 10-2012-0055189

(51) Int. Cl. G02B 5/28; H01S 3/10

(52) U.S. Cl. 372/20; 359/578

(57) ABSTRACT

Disclosed are a wavelength tunable optical filter and an optical source which can achieve a wideband, a high speed wavelength tuning and a consecutive variation, and can be simply manufactured. The wavelength tunable optical filter according to an exemplary embodiment of the present disclosure includes a first optical deflector driven by an electrical signal and configured to control the propagation direction of an incident light and a Fabry-Perot (FP) filter configured to filter the incident light having passed through the first optical deflector to output a selected light having a particular wavelength.

### CROSS-REFERENCE TO RELATED APPLICATIONS

This application is based on and claims priority from Korean Patent Application No. 10-2012-0055189, filed on May 24, 2012, with the Korean

Intellectual Property Office, the disclosure of which is incorporated herein in its entirety by reference.

### TECHNICAL FIELD

The present disclosure relates to a high speed and wideband wavelength tunable optical filter and an optical source used in an optical communication apparatus and an optical measuring apparatus.

### BACKGROUND

Wavelength tunable optical filters have been developed with various driving techniques and structures, and generally exhibit a reciprocal relationship between a wavelength tuning speed and a wavelength tuning range. Most optical filters currently commercialized to meet the requirement of sufficient tuning range characteristics have millisecond level switching speed characteristics corresponding to a low speed from a viewpoint of a tuning speed. In contrast, most optical filters having a high switching speed ranging from millisecond to nanosecond level have limitations of narrow tuning range characteristics due to the operation principle.

A Fabry-Perot (FP) filter which is one of representative wavelength tunable filters in the related art is configured by a linear resonator including two mirrors. Incident lights are consecutively reflected by the two mirrors or a portion of lights are transmitted through the mirrors to make interference between the generated lights. As a result, a resonance occurs at a regular wavelength interval to show periodical transmission characteristics according to the wavelengths. In order to tune the wavelength of the FP filter, various methods are used such as, for example, a method of controlling the interval between the two mirrors or changing a refractive index of the material that forms the FP filter.

For the method of controlling the interval between the two mirrors, a technique is used in which each of the two mirrors that form the FP filter is attached to a piezoelectric transducer (PZT) to apply a voltage, and the interval between the two mirrors changes due to an expansion of the PZT by the applied voltage, thereby tuning the wavelength of the FP filter. However, the operation speed for this method is restricted to a millisecond level since the method implements the wavelength tuning through a mechanical modification.

For the method of changing the refractive index, when an electric field having an intensity equal to or larger than a predetermined intensity is applied in a liquid crystal, a Freedericksz transition phenomenon is generated in which liquid crystal molecules are rearranged, thereby resulting in a change in the refractive index of the liquid crystal. A liquid crystal FP filter is implemented by varying the refractive index of the liquid crystal within the resonator. The liquid crystal FP filter has an operation speed limited to several tens to hundreds of millisecond, and the polarization characteristics may cause a problem.

In addition, there is a micro machined FP filter implemented with controlling the interval between the mirrors of the FP filter using a semiconductor that can be deformed minutely by the electrostatic force or heat. While the integration and stability may be improved based on a semiconductor device technology, there is still a limitation in the speed of millisecond or several tens of millisecond level.

A wavelength tunable filter that uses a mode coupling in which energy exchange is generated between modes by the perturbation in an optical waveguide includes a polarization mode conversion filter and a spatial mode conversion filter. However, these filters also have limitation in that the operation speed is limited to several tens to hundreds of millisecond level and the tuning range is very narrow.

A wavelength tunable filter using a Mach-Zender (MZ) interferometer having a structure in which a phase modulator is located on the optical waveguide through which a light passes between two 3 dB connectors, can operate at a high speed of several tens of nanosecond by using a phase modulation apparatus formed with LiNbO₃, but has disadvantages in that a structure is complex and fabrication is difficult.

There is an implementation method that changes the period of grating by applying tension or heat to an optical fiber diffraction grating having a refractive index periodically changed along an optical fiber. However, since even such a case uses the PZT for the mechanical modification, the operation speed is limited to millisecond level.

The wavelength of a distributed feedback (DFB)/distributed Bragg reflector (DBR) filter and a grating assisted co-directional coupler (GACC) filter having a semiconductor waveguide type similar to a semiconductor laser diode can be varied up to several tens of nanometer through a control of injecting a current. However, there is generally a limited application range such as a narrow variability, and discontinuity and instability of the variation.

As described above, the wavelength tunable filters in the related art do not provide the structure which satisfies all of a wideband tuning, a consecutive tuning and productivity as well as achieving an operation at a high speed equal to or faster than millisecond level.

### SUMMARY

The present disclosure has been made in an effort to solve the problems and intends to provide a wavelength tunable optical filter and an optical source which can achieve a wideband, a high speed wavelength tuning and a consecutive tuning, and can be simply manufactured.

An exemplary embodiment of the present disclosure provides a wavelength tunable optical filter including: a first optical deflector driven by an electrical signal and configured to control a propagation direction of an incident light; and a Fabry-Perot (FP) filter configured to filter the incident light having passed through the first optical deflector to output a selected light having a particular wavelength.

The first optical deflector may determine a deflection angle by varying a refractive index of a configuration material through an input voltage or current.

The FP filter may be fixed to have a predetermined angle with respect to the incident light, and the wavelength of the selected light may be determined according to an angle at which the input light having passed through the first optical deflector is incident on a plane of the FP filter.

The wavelength tunable optical filter according to the present disclosure may further include a second optical deflector driven by an electrical signal and configured to control the propagation direction of the selected light such that the selected light can be output in a direction parallel to the incident light.

Another exemplary embodiment of the present disclosure provides a wavelength tunable optical source including: a gain medium configured to generate a light; a first lens configured to refract the light generated at the gain medium to output an incident light in a parallel type ; a first optical deflector driven by an electrical signal and configured to control the propagation direction of the incident light; a Fabry-Perot (FP) filter configured to filter the light having passed through the first optical deflector to output a selected light having a particular wavelength; a second optical deflector driven by the electrical signal and configured to control the propagation direction of the selected light such that the selected light can be output in a direction parallel to the incident light; and a total reflection mirror configured to reflect the incident light having passed through the second optical deflector so that the incident light having passed through the second optical deflector can be returned to the gain medium.

Yet another exemplary embodiment of the present disclosure provides a wavelength tunable optical source including: a gain medium configured to generate a light; a first lens configured to refract the light generated at the gain medium to output an incident light in a parallel type; a first optical deflector driven by an electrical signal and configured to control the propagation direction of the incident light; a Fabry-Perot (FP) filter configured to filter the light having passed through the first optical deflector to output a selected light having a particular wavelength; a second lens configured to refract the selected light into the same focal direction; and a total reflection mirror located at a position corresponding to a focal length of the second lens and configured to reflect the light having passed through the second lens so that the incident light having passed through the second lens can be returned to the gain medium.

According to the exemplary embodiments of the present disclosure, it is possible to implement a wavelength tunable optical filter which satisfies both a wideband wavelength tunability and a high speed and consecutive tunability by using an optical deflector configured to control the deflection angle of the incident light by an electrical signal and an FP filter.

According to the exemplary embodiments of the present disclosure, it is possible to implement a wavelength tunable optical source which satisfies both a wideband wavelength tunability and a high speed and consecutive tunability by integrating the proposed wavelength tunable optical filter and an optical gain medium, and has structurally stable tuning characteristics.

According to the exemplary embodiments of the present disclosure, since both the wavelength tunable optical filter and the optical source may be manufactured with a relatively simple fabrication process in comparison with the related art, there is an advantage of reducing manufacturing costs.

In the following detailed description, reference is made to the accompanying drawings, which form a part hereof. The illustrative embodiments described in the detailed description, drawing, and claims are not meant to be limiting. Other embodiments may be utilized, and other changes may be made, without departing from the spirit or scope of the subject matter presented here.

### BRIEF DESCRIPTION OF THE DRAWINGS

FIG. 1 is a configuration diagram of a wavelength tunable optical filter according to an exemplary embodiment of the present disclosure.

FIG. 2 is a configuration diagram of a wavelength tunable optical filter according to another exemplary embodiment of the present disclosure.

FIG. 3 is a configuration diagram of a wavelength tunable optical source according to an exemplary embodiment of the present disclosure.

FIG. 4 illustrates a wavelength tunable optical filter in which the wavelength tunable optical filter of FIG. 2 is integrated on a planar lightwave circuit substrate as an application example according to the present disclosure.

FIG. 5 is a view illustrating an example of implementing a wavelength tunable optical source by optically coupling the wavelength tunable optical filter of FIG. 4 with a reflective semiconductor optical amplifier through a lens.

FIG. 6 is a view illustrating an example of implementing a wavelength tunable optical source by monolithically integrating the wavelength tunable optical source of FIG. 5.

FIG. 7 is a configuration diagram of a wavelength tunable optical source according to another exemplary embodiment of the present disclosure.

### DETAILED DESCRIPTION

The object, features and advantages will be described in detail with reference to the accompanying drawings and thus a person skilled in the art will be able to easily embody the technical spirit of the present disclosure. When it is determined that a detailed description of the well-known techniques in the art related to the present disclosure makes the gist of the present disclosure unnecessarily ambiguous in understanding the present disclosure, a detailed description thereof will be omitted. Hereinafter, exemplary embodiments of the present disclosure will be described with reference to the accompanying drawings.

FIG. 1 is a configuration diagram of a wavelength tunable optical filter according to an exemplary embodiment of the present disclosure.

Referring to FIG. 1, the wavelength tunable optical filter according to the exemplary embodiment of the present disclosure includes a first optical deflector 101 driven by an electrical signal and configured to control the propagation direction of an incident light LIN and an FP filter 103 configured to filter lights LB1 and LB2 having passed through the first optical deflector 101 to output selected lights LF1 and LF2 each having a particular wavelength.

The first optical deflector 101 may be implemented as an electro-optical deflector capable of operating at a high speed based on the material characteristics in which a refractive index is changed when driven by an electrical signal, that is, by the application of voltage or current. A deflection angle of the incident light LIN may be controlled by varying a refractive index of a configuration material within the first optical deflector 101 by applying the electrical signal. For example, when a light having passed through the first optical deflector 101 in a state where the electrical signal is not applied is LB2, a light having passed through the first optical deflector 101 with the electrical signal in a predetermined level is applied may be LB1. The FP filter 103 is implemented in a fixed type to have a predetermined angle with respect to the incident light LIN, and the wavelengths of the selected lights LF1 and LF2 to be output are determined according to the incident angles of the lights LB 1 and LB2 to the plane of the FP filter 103. Specifically, the selectivity for the wavelength of the FP filter 103 changes according to the incident angle Φ of the incident light with respect to a direction perpendicular to the plane of the FP filter 103 as defined in [Equation 1] below, and the free spectral range (FSR) Δλ is determined as defined in [Equation 2].

2ndcosφ=mλ [Equation 1]

>λ=λ²/(2ndcosφ+λ) [Equation 2]

In the above equations, n denotes an inner refractive index of the FP filter 103, d denotes an interval between two thin films included in the FP filter 103, and m denotes a resonance order.

The wavelength tuning speed of the optical filter according to the exemplary embodiment is independently determined by driving the first optical deflector 101. The wavelength tuning range is determined in association with a varied deflection angle by the first optical deflector 101, the interval between the thin films of the FP filter 103, the refractive index and an incident angle. The wavelength tuning range δ λ is determined as defined in [Equation 3] below.

δλ=2nd[cosφ_{E}−cosφ_{S}]/m [Equation 3]

In [Equation 3], φ_{E} denotes a variation start angle and φ_{S} denotes a variation end angle.

Accordingly, the tuning range may be maximized through an optimal design for the above parameters, and a continuous variability which is an inherent property of the FP filter 103 can be manifested. In order to improve the selectivity of the wavelength and expand the tuning range, an FP Comb filter in which two FP filters having slightly different FSRs are connected in parallel may be applied.

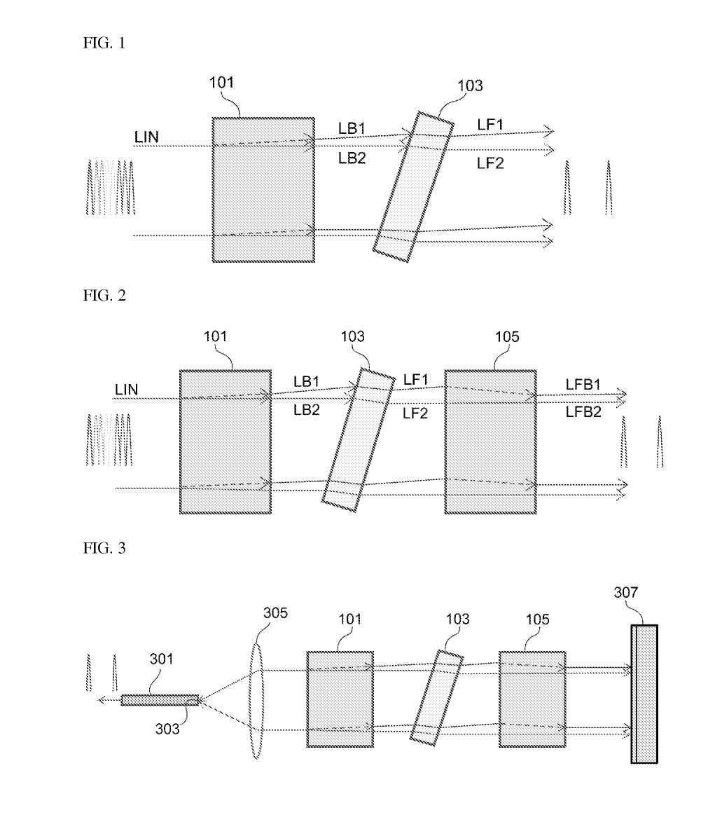

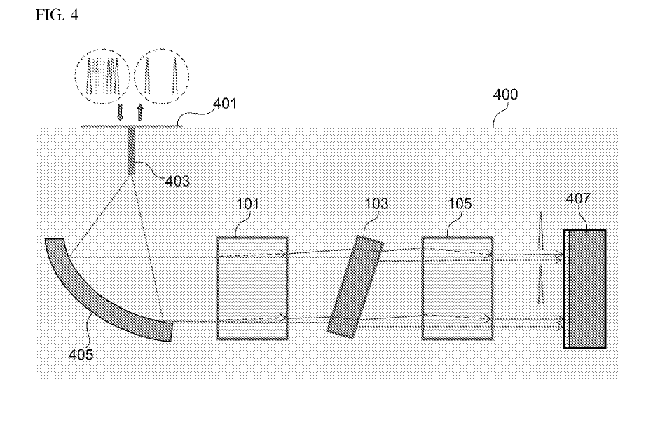

FIG. 2 is a configuration diagram of a wavelength tunable optical filter according to another exemplary embodiment of the present disclosure.

As illustrated in FIG. 2, a second optical deflector 105 may be further included to make the optical axes of input and output lights to be parallel to each other in the wavelength tunable optical filter of FIG. 1.

The second optical deflector 105, as in the first optical deflector 101, is driven in such a way that the refractive index of a configuration material is varied by an electrical signal to control the propagation direction of the input light, and the selected lights LF1 and LF2 each having a particular wavelength and output from the FP filter 103 are output in a direction parallel to the incident light LIN (LFB1 and LFB2).

Meanwhile, the first and second optical deflectors 101 and 105 may be applied to existing acousto-optic deflector, thermo-optic deflector and liquid crystal deflector according to an implementation scheme.

FIG. 3 is a configuration diagram of a wavelength tunable optical source according to an exemplary embodiment of the present disclosure.

Referring to FIG. 3, the wavelength tunable optical source according to the exemplary embodiment of the present disclosure includes a gain medium 301 configured to generate a light, a first lens 305 configured to refract the light generated at the gain medium 301 to output an incident light in a parallel type, the first optical deflector 101 driven by an electrical signal to control the propagation direction of the incident light, the FP filter 103 configured to filter the light having passed through the first optical deflector 101 to output a selected light having a particular wavelength, the second optical deflector 105 driven by an electrical signal to control the propagation direction of the selected light so that the selected light output from the FP filter 103 is output in a direction parallel to the incident light, and a total reflection mirror 307 configured to reflect the light having passed through the second optical deflector 105 to be returned to the gain medium 301.

The first optical deflector 101, the FP filter 103 and the second optical deflector 105 configure the wavelength tunable filter as shown in the exemplary embodiment of FIG. 2, and an anti-reflection thin film 303 is formed at an end part of the gain medium 301 so that the returned selected light having the particular wavelength is output to the outside.

The wavelength tuning range of the wavelength tunable optical source is determined by overlapping between a wavelength bandwidth of the gain medium 301 and a tuning bandwidth of the wavelength tunable filter, and the tuning speed is independently determined by the speed characteristics of the wavelength tunable filter.

It may be considered that the wavelength tunable optical source according to the exemplary embodiment employs the FP filter 103 instead of a diffraction grating in comparison with an external resonator variable optical source of a Littman-Metcalf or Littrow type in the related art in which a variable deflector is integrated. However, when considering an actual limited factor in manufacturing the filter, it is possible to design the present disclosure employing the FP filter 103 to obtain a larger wavelength tuning range for the same change of the variable angle by the deflector and to further improve the performance of the filter.

Meanwhile, in a method of actually implementing the wavelength tunable optical filter and the wavelength tunable optical source of FIGS. 1 to 3, the wavelength tunable filter and the wavelength tunable optical source may be implemented using a method of manufacturing packaging of bulk-optics by individually preparing components in each configuration unit, or implemented by monolithically integrating the wavelength tunable filter and the wavelength tunable optical source on a semiconductor or silica-based planar lightwave circuit (PLC).

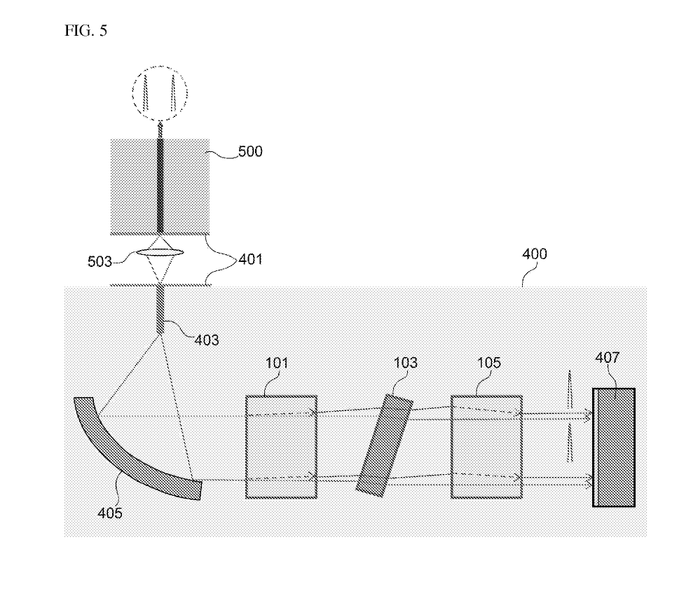

FIG. 4 is a view illustrating an example of implementing a wavelength tunable optical filter by integrating the wavelength tunable optical filter of FIG. 2 on a planar lightwave circuit substrate as an application example according to the present disclosure.

As illustrated in FIG. 4, the wavelength tunable optical filter according to the present disclosure may be implemented on a planar lightwave circuit 400 based on silica and a III-V compound (e.g., InP, GaAs and GaSb). The wavelength tunable optical filter includes a passive lightwave circuit 403 for a single-mode lightwave, a curved type reflection minor 405 formed by deeply etching up to the substrate layer of the planar lightwave circuit 400, the FP filter 103 and a total reflection minor 407, and the first and second optical deflectors 101 and 105 configured to change the direction of an input light through a change in a refraction index caused by an application of a voltage or a current. It is well known that the curved type reflection minor 405 can make an optical beam originated and divergent from the end of the passive lightwave circuit 403 connected to the planar lightwave circuit 400 to be a parallel light through a total reflection by deeply etching up to the substrate on the plane of the planar lightwave circuit 400 in a curve shape having a parabolic form. See, for example, JOURNAL OF LIGHTWAVE TECHNOLOGY, VOL. 28, No. 5, MAR. 1, 2010. Although the present application example includes the total reflection mirror 407 for implementing a configuration of the reflective filter for the input light, the total reflection mirror 407 may be excluded and the wavelength tunable optical filter may be manufactured by additionally inserting the curved type reflection mirror and the passive lightwave circuit (not shown) for implementing a configuration of a transmissive filter.

In a detailed method of implementing the first and second optical deflectors 101 and 105, when a voltage is reversely applied to or a current is forwardly injected to the planar lightwave circuit 400 based on the III-V compound (e.g., InP, GaAs and GaSb) through a P/N junction formed at a prism shaped part, the refractive index is changed according to the change in an electron density of a core layer, and as a result, a change in the propagation direction of beams passing according to Snell's law may be induced. See, for example, U.S. Pat. No. 6,810,047.

In a case of the FP filter 103, when the planar lightwave circuit 400 is etched to have a rectangle having a predetermined width up to a substrate depth, FP filter characteristics appear with respect to beams passing through the planar lightwave circuit 400. See, for example, JOURNAL OF LIGHTWAVE TECHNOLOGY, VOL. 28, NO. 5, MAR. 1, 2010.

FIG. 5 is a view illustrating an example of implementing a wavelength tunable optical source by optically coupling the wavelength tunable optical filter of FIG.

4 with a reflective semiconductor optical amplifier through a lens.

Referring to FIG. 5, an optical beam generated by a reflective semiconductor optical amplifier (RSOA) 500 by applying a current injection is focused on and guided by the passive lightwave circuit 403 through a lens 503, and the optical beam is divergent from the planar lightwave circuit 400 connected to the passive lightwave circuit 403, thereby causing a total reflection from the curved type reflection mirror 405. Here, the position of an end cross-section of the passive lightwave circuit 403 is set such that an incident beam is totally reflected through the curved type reflection mirror 405 to become a parallel light. The optical beam converted into the parallel light passes through the FP filter 103 with a state where the propagation direction is changed by the first optical deflector 101 by a predetermined angle, passes through the second optical deflector 105 configured to recover the propagation direction to be vertically incident on the total reflection minor 407, and reversely returns by the total reflection mirror 407 to go back to the reflective semiconductor optical amplifier 500, thereby forming an entire resonator.

FIG. 6 is a view illustrating an example of implementing a wavelength tunable optical source by monolithically integrating the wavelength tunable optical source of FIG. 5.

Referring to FIG. 6, a reflective semiconductor optical amplifier 600 of a substrate-based material, the passive lightwave circuit 403 and the planar lightwave circuit 400 are integrated on a semiconductor substrate capable of making an optical source containing materials based on III-V compound (e.g., InP, GaAs and GaSb). An integrated wavelength tunable optical source can be implemented by forming the curved type reflection minor 405, the FP filter 103 and the total reflection minor 407 by deeply etching the planar lightwave circuit 400 up to the substrate depth, and forming the first and second optical deflectors 101 and 105 configured to change the direction of an input light through the change of a refractive index by a voltage application or a current injection.

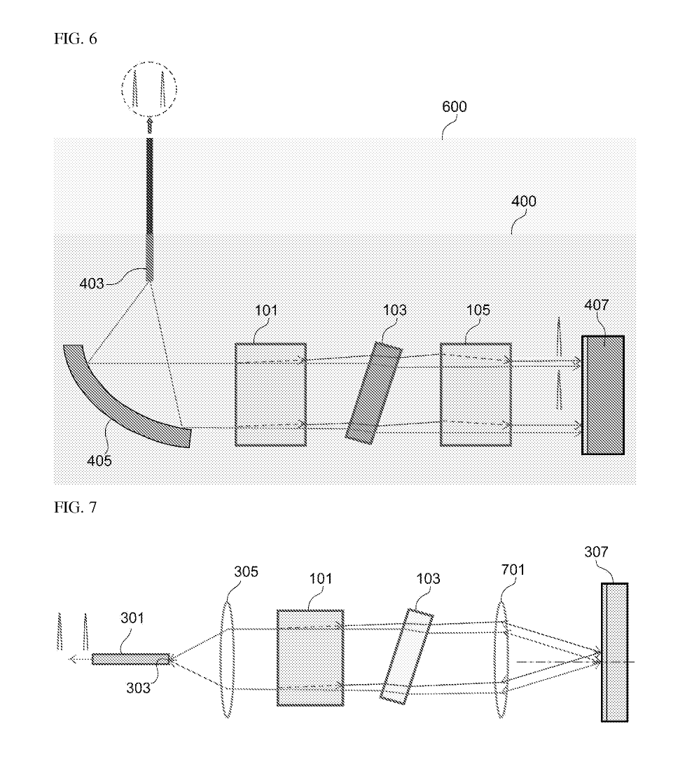

FIG. 7 is a configuration diagram of a wavelength tunable optical source according to another exemplary embodiment of the present disclosure.

Referring to FIG. 7, the wavelength tunable optical source according to another exemplary embodiment of the present disclosure includes the gain medium 301 configured to generate a light, the first lens 305 configured to refract the light generated at the gain medium 301 to output an incident light in a parallel type, the first optical deflector 101 driven by the electrical signal and configured to control the propagation direction of the incident light, the FP filter 103 configured to filter the light having passed through the first optical deflector 101 to output the selected light having a particular wavelength, a second lens 701 configured to refract the selected light having the particular wavelength output from the FP filter 103 in the same focal direction and the total reflection minor 307 located at a position corresponding to a focal length of the second lens 702 and configured to reflect the light having passed through the second lens 701 to return to the gain medium 301.

In the present exemplary embodiment, a lens 701 is inserted instead of the second optical deflector 105 of FIG. 3, and the total reflection minor 307 is positioned at the focal length of the lens 701 to make the selected light reflected by the total reflection mirror 307 having a specific wavelength to return. As a result, an optical source having a high wavelength tuning speed and a wideband tuning range as in FIG. 3 can be implemented. Characteristics of other configurations and effects thereof are the same as those described through the exemplary embodiment of FIG. 3.

Although the present disclosure is specifically described in accordance with the exemplary embodiments of the present disclosure described above, it is to be noted that the exemplary embodiments are illustrative only and not intended to be limiting. Further, a skilled person in the art would understand that the various embodiments will be made without departing from the spirit of the present disclosure.

What is claimed is:

1. A wavelength tunable optical filter, comprising:
a first optical deflector driven by an electrical signal and configured to control a propagation direction of an incident light; and
a Fabry-Perot (FP) filter configured to filter the incident light having passed through the first optical deflector to output a selected light having a particular wavelength.

2. The wavelength tunable optical filter of claim 1, wherein the first optical deflector determines a deflection angle of the incident light by varying a refractive index of a configuration material through an input voltage or current.

3. The wavelength tunable optical filter of claim 1, wherein the FP filter is fixed to have a predetermined angle with respect to the incident light, and the wavelength of the selected light is determined according to an angle at which the incident light having passed through the first optical deflector is incident on a plane of the FP filter.

4. The wavelength tunable optical filter of claim 1, further comprising a second optical deflector driven by an electrical signal and configured to control the propagation direction of the selected light such that the selected light can be output in a direction parallel to the incident light.

5. The wavelength tunable optical filter of claim 4, wherein the first and second optical deflectors determine deflection angles of the incident light and the selected light by varying refractive indexes of configuration materials through an input voltage or current.

6. The wavelength tunable optical filter of claim 5, wherein the first and second optical deflectors deflect the incident light and the selected light by an equal angle in opposite directions.

7. A wavelength tunable optical source, comprising:
a gain medium configured to generate a light;
a first lens configured to refract the light generated at the gain medium to output an incident light in a parallel type;
a first optical deflector driven by an electrical signal and configured to control a propagation direction of the incident light;
a Fabry-Perot (FP) filter configured to filter the incident light having passed through the first optical deflector to output a selected light having a particular wavelength;
a second optical deflector driven by the electrical signal and configured to control the propagation direction of the selected light such that the selected light can be output in a direction parallel to the incident light; and
a total reflection mirror configured to reflect the incident light having passed through the second optical deflector so that the incident light having passed through the second optical deflector can be returned to the gain medium.

8. The wavelength tunable optical source of claim 7, wherein the first and second optical deflectors determine deflection angles of the incident light and the selected light by varying refractive indexes of configuration materials through an input voltage or current.

9. The wavelength tunable optical source of claim 7, wherein the FP filter is fixed to have a predetermined angle with respect to the incident light, and the wavelength of the selected light is determined according to an angle at which the incident light having passed through the first optical deflector is incident on a plane of the FP filter.

10. A wavelength tunable optical source, comprising:
a gain medium configured to generate a light;
a first lens configured to refract the light generated at the gain medium to output an incident light in a parallel type;
a first optical deflector driven by an electrical signal and configured to control a propagation direction of the incident light;
a Fabry-Perot (FP) filter configured to filter the incident light having passed through the first optical deflector to output a selected light having a particular wavelength;
a second lens configured to refract the selected light into the same focal direction; and
a total reflection mirror located at a position corresponding to a focal length of the second lens and configured to reflect the incident light having passed through the second lens so that the incident light having passed through the second lens can be returned to the gain medium.

11. The wavelength tunable optical source of claim 10, wherein the first optical deflector determines a deflection angle of the incident light by varying a refractive index of a configuration material through an input voltage or current.

12. The wavelength tunable optical source of claim 10, wherein the FP filter is fixed to have a predetermined angle with respect to the incident light, and the wavelength of the selected light is determined according to an angle at which the incident light having passed through the first optical deflector is incident on a plane of the FP filter.
